(19) United States
(12) Patent Application Publication
(10) Pub. No.: US 2020/0172046 A1
(43) Pub. Date: Jun. 4, 2020

(54) WEBBING RETRACTOR

(71) Applicant: KABUSHIKI KAISHA TOKAI-RIKA-DENKI-SEISAKUSHO, Aichi-ken (JP)

(72) Inventors: Tomoya OWAKI, Aichi-ken (JP); Takuhiro SAITO, Aichi-ken (JP); Kazuhiro YAMADA, Aichi-ken (JP)

(21) Appl. No.: 16/682,407

(22) Filed: Nov. 13, 2019

(30) Foreign Application Priority Data
Nov. 29, 2018 (JP) 2018-224240

(51) Int. Cl. B60R 22/343; B60R 22/405; B60R 22/415; B60W 40/08

(52) U.S. Cl. CPC B60R 22/343; B60R 22/405; B60R 2022/4666; B60W 40/08; B60R 22/415

(57) ABSTRACT

A webbing retractor including: a take-up shaft that can take-up a webbing that is applied to a passenger, that takes-up the webbing by being rotated in a take-up direction, and that is rotated in a pull-out direction due to the webbing being pulled-out; a restricting member that, by being operated, restricts rotation of the take-up shaft in the pull-out direction; a driving portion that, by being electrically driven, changes an operating state of the restricting member; and a control section that acquires an acceleration of any of the webbing, the passenger or a vehicle, that computes jerk related to the acceleration, and that controls the driving portion such that the restricting member operates in a case in which the acceleration exceeds a first threshold value and the jerk exceeds a second threshold value.

### CROSS-REFERENCE TO RELATED APPLICATION

This application is based on and claims priority under 35 USC 119 from Japanese Patent Application No. 2018-224240 filed on Nov. 29, 2018, the disclosure of which is incorporated by reference herein.

### BACKGROUND

### Technical Field

The present disclosure relates to a webbing retractor that takes-up a webbing that is applied to a passenger.

### Related Art

Japanese Patent Application Laid-Open (JP-A) No. 2002-234417 discloses a webbing retractor having a locking mechanism that limits pulling-out of a webbing at the time of an emergency. This locking mechanism is driven by electrical means such as a motor or a solenoid or the like, based on a collision prediction signal from a collision predicting device. Further, in JP-A No. 2002-234417, acceleration of the vehicle is given as an example of a physical amount that is made to be the sensing condition of the collision predicting device.

The collision predicting device, at which acceleration that is a physical amount is made to be the sensing condition as described above, is structured so as to output a collision prediction signal in a case in which the acceleration exceeds a predetermined threshold value. On the other hand, in a case in which only acceleration is made to be the sensing condition, there are cases in which the locking mechanism is operated even though the acceleration is actually low, due to the acceleration, that is detected by the sensor, having noise.

Concretely, as shown in FIG. 7, in a case in which the detected acceleration projects-out higher than and overshoots the actual acceleration, the locking mechanism is operated even though the actual acceleration does not exceed the threshold value.

### SUMMARY

In view of the above-described circumstances, an object of the present disclosure is to provide a webbing retractor that can suppress effects of noise at a locking mechanism that uses acceleration in control and is electrically operated.

A webbing retractor of a first aspect of the present disclosure has: a take-up shaft that can take-up a webbing that is applied to a passenger, that takes-up the webbing by being rotated in a take-up direction, and that is rotated in a pull-out direction due to the webbing being pulled-out; a restricting member that, by being operated, restricts rotation of the take-up shaft in the pull-out direction; a driving portion that, by being electrically driven, changes an operating state of the restricting member; and a control section that acquires an acceleration of any of the webbing, the passenger or a vehicle, that computes jerk related to the acceleration, and that controls the driving portion such that the restricting member operates in a case in which the acceleration exceeds a first threshold value and the jerk exceeds a second threshold value.

In a webbing retractor of a second aspect of the present disclosure, the webbing retractor of the first aspect further has a rotational angle sensor that detects a rotational angle of the take-up shaft, wherein the control section acquires the acceleration of the webbing that is computed based on the rotational angle that is detected.

In a webbing retractor of a third aspect of the present disclosure, in the webbing retractor of the second aspect, the control section corrects the acceleration of the webbing based on the rotational angle.

In a webbing retractor of a fourth aspect of the present disclosure, in the webbing retractor of the second aspect, the control section changes at least one of the first threshold value or the second threshold value based on the rotational angle.

In a webbing retractor of a fifth aspect of the present disclosure, the webbing retractor of the first aspect further has a pulled-out amount sensor that detects a pulled-out amount of the webbing, wherein the control section acquires the acceleration of the webbing that is computed based on the pulled-out amount that is detected.

In a webbing retractor of a sixth aspect of the present disclosure, the webbing retractor of the first aspect further has an acceleration sensor that detects the acceleration of the vehicle, wherein the control section acquires the acceleration from the acceleration sensor.

In a webbing retractor of a seventh aspect of the present disclosure, in the webbing retractor of any one of the first through sixth aspects, the control section drives the driving portion such that operation of the restricting member stops in a case in which the acceleration falls below the first threshold value.

In the webbing retractor of the first aspect, the webbing is taken-up due to the take-up shaft being rotated in the take-up direction, and the take-up shaft is rotated in the pull-out direction due to the webbing being pulled-out. This webbing retractor has a so-called locking mechanism by which rotation of the take-up shaft in the pull-out direction is restricted due to the restricting member operating. The operating state of the locking mechanism is changed accompanying the driving of the driving portion that is driven electrically. Therefore, for example, pulling-out of the webbing is restricted due to the driving portion being driven electrically. Further, the control section is structured so as to be able to operate the restricting member in a case in which the acceleration of any of the webbing, the passenger or the vehicle exceeds a first threshold value and the jerk, which is the derivative of the acceleration, exceeds a second threshold value.

Here, even in a case in which the acquired acceleration overshoots and exceeds the first threshold value due to the effects of noise or the like, the control section does not operate the locking mechanism unless the jerk exceeds the second threshold value. Therefore, at this webbing retractor, the locking mechanism being operated even though the actual acceleration does not exceed the threshold value is suppressed. Namely, in accordance with the webbing retractor of the first aspect, the effects of noise can be suppressed at a locking mechanism that uses acceleration in control and that is electrically operated.

The webbing retractor of the second aspect acquires the acceleration of the webbing from the rotational angle of the take-up shaft. In accordance with this webbing retractor, because the rotational angle sensor can be provided at any of the rotating members that rotate interlockingly with the take-up shaft, assembly into a device is easy, and the device can be made to be compact.

In the webbing retractor of the third aspect, the control section acquires the acceleration of the webbing from the rotational angle of the take-up shaft, and corrects the acceleration of the webbing based on the rotational angle. In a case in which the pulled-out amount of the webbing is small and the total rotational angle of the spool is small, the wound amount of the webbing at the take-up shaft is large, and therefore, the wound diameter of the webbing is large. In contrast, in a case in which the pulled-out amount of the webbing is large and the total rotational angle of the spool is large, the wound amount of the webbing at the take-up shaft is small, and therefore, the wound diameter of the webbing is small. Thus, in a case in which the wound diameter of the webbing is not corrected, the more the webbing is pulled-out, the smaller the acceleration of the webbing is computed to be. In contrast, in accordance with this webbing retractor, by correcting the acceleration of the webbing based on a rotational angle that is correlated with the wound amount of the webbing, the locking mechanism can be operated based on acceleration and jerk that are more accurate.

In the webbing retractor of the fourth aspect, the control section acquires the acceleration of the webbing from the rotational angle of the take-up shaft, and changes at least one of the first threshold value and the second threshold value based on the rotational angle.

As described above, because the wound diameter of the webbing at the take-up shaft changes in accordance with the pulled-out amount of the webbing, in a case in which the wound diameter of the webbing is not corrected, the more the webbing is pulled-out, the smaller the acceleration of the webbing is computed to be. Thus, in accordance with this webbing retractor, by correcting the threshold value, which is the object of comparison with the acceleration, instead of correcting the acceleration, the locking mechanism can be operated accurately.

In the webbing retractor of the fifth aspect, the pulled-out amount of the webbing is used in acquiring the acceleration of the webbing. In accordance with this webbing retractor, because control is not affected by the wound state of the webbing at the take-up shaft, the locking mechanism can be operated accurately.

In the webbing retractor of the sixth aspect, the acceleration of the vehicle is made to be the condition for operation of the locking mechanism. In accordance with this webbing retractor, because the acceleration sensor that is provided at the vehicle can be used, the cost of the device can be kept down.

In the webbing retractor of the seventh aspect, stopping of the operation of the locking mechanism is carried out by control that uses only acceleration as a condition. In accordance with this webbing retractor, by stopping operation of the locking mechanism based on only the acceleration and regardless of the jerk, operation of the locking mechanism can be stopped rapidly even in a case in which the acquired acceleration value is not stable, i.e., a case in which the jerk moves vertically.

### BRIEF DESCRIPTION OF THE DRAWINGS

Exemplary embodiments of the present disclosure will be described in detail based on the following figures, wherein:

FIG. 1 is an exploded perspective view showing, in a disassembled manner, a webbing retractor relating to first and second embodiments;

FIG. 2 is a rear view showing main portions of the webbing retractor;

FIG. 3 is a rear view that corresponds to FIG. 2 and shows main portions of the webbing retractor in a state in which a W pawl has swung;

FIG. 4 is a cross-sectional view that is cut along line 4-4 of FIG. 2 and shows a cross-section of main portions of the webbing retractor;

FIG. 5 is a graph showing acceleration and jerk in a case in which a locking mechanism is not operating;

FIG. 6 is a graph showing acceleration and jerk in a case in which the locking mechanism is operating;

FIG. 7 is a graph showing acceleration in a case in which a locking mechanism is operating, in a comparative example;

FIG. 8 is a block diagram of the webbing retractor relating to the first and second embodiments;

FIG. 9 is a block diagram of a webbing retractor relating to a third embodiment;

FIG. 10 is a block diagram of a webbing retractor relating to a fourth embodiment; and

FIG. 11 is a block diagram of a webbing retractor relating to a fifth embodiment.

### DETAILED DESCRIPTION

### First Embodiment

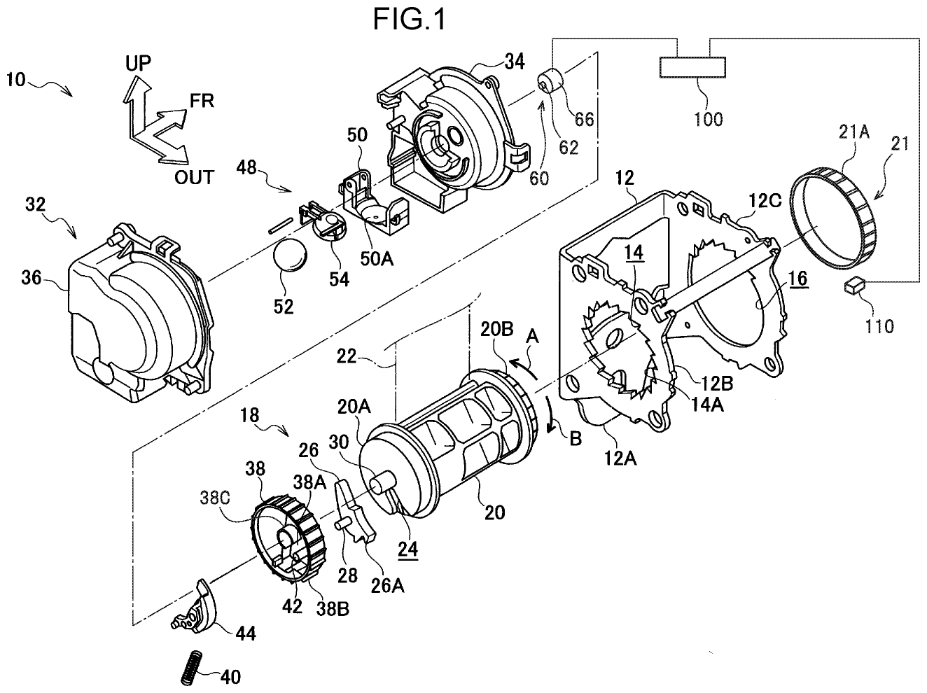

A webbing retractor 10 relating to a first embodiment of the present disclosure is shown in FIG. 1 in an exploded perspective view that is seen obliquely from a rear side, outer side and upper side. Note that, in the drawings, the vehicle front side in the state in which the webbing retractor 10 is mounted to a vehicle is indicated by arrow FR, the vehicle transverse direction outer side is indicated by arrow OUT, and the vehicle upper side is indicated by arrow UP. Further, when merely longitudinal and vertical directions are used in the following description, they refer to the longitudinal of the vehicle longitudinal direction and the vertical of the vehicle vertical direction.

As shown in FIG. 1, the webbing retractor 10 of the present embodiment has a frame 12 that is formed in a substantial U-shape as seen from the vehicle upper side. The frame 12 has a back plate 12A that extends in the vehicle vertical direction with the vehicle transverse direction being the thickness direction thereof, and a leg plate 12B and a leg plate 12C that respectively are bent and extend from the vehicle longitudinal direction both end portions of the back plate 12A toward the vehicle transverse direction outer side and are disposed so as to face one another. Further, the webbing retractor 10 is installed in the vehicle body by the back plate 12A of the frame 12 being fixed to the vehicle body.

A placement hole 14 and a placement hole 16 that are substantially circular are formed in the leg plate 12B and the leg plate 12C, respectively. The placement hole 14 and the placement hole 16 face one another in the vehicle longitudinal direction. Further, ratchet teeth 14A (internal teeth) that structure a locking mechanism 18 are formed at the entire outer periphery of the placement hole 14.

A spool 20, which is substantially solid cylindrical and serves as a take-up shaft, is provided between the leg plate 12B and the leg plate 12C of the frame 12. One end 20A that is at the rear side (the leg plate 12B side) of the spool 20 is disposed within the placement hole 14 of the leg plate 12B. Another end 20B that is at the front side (the leg plate 12C side) of the spool 20 is disposed within the placement hole 16 of the leg plate 12C. Due thereto, the spool 20 can rotate in the peripheral direction in a state in which the axial direction thereof is parallel to the longitudinal direction. Note that when merely axial direction, radial direction and peripheral direction are used hereinafter, they refer to the axial direction, the radial direction and the peripheral direction of the spool, unless otherwise indicated.

The proximal end side of a webbing 22 (belt) that is shaped as an elongated strip is anchored on the spool 20, and the webbing 22 is taken-up onto the spool 20 from the proximal end side of the webbing 22. At the time when the spool 20 is rotated in a take-up direction (the arrow A direction in FIG. 1 which is one peripheral direction), the webbing 22 is taken-up onto the spool 20. On the other hand, at the time when the webbing 22 is pulled-out from the spool 20, the spool 20 is rotated in a pull-out direction (the arrow B direction in FIG. 1 which is another peripheral direction). The webbing 22 extends-out from the frame 12 toward the upper side, and is applied to a passenger who is seated in a seat of the vehicle.

A spiral spring that serves as a take-up urging means is connected to the another end 20B of the spool 20. The spiral spring is disposed at the front side of the frame 12 (the front side of the leg plate 12C). The spiral spring urges the spool 20 in the take-up direction, and due thereto, urging force in the take-up direction of the spool 20 is applied to the webbing 22. Therefore, at the time when the webbing 22 is applied to the passenger, slack of the webbing 22 is eliminated by the urging force of the spiral spring. At the time when application of the webbing 22 to the passenger is released, the webbing 22 is taken-up onto the spool 20 by the urging force of the spiral spring.

Further, a ring 21 that is shaped as a cylindrical tube is connected to the another end 20B of the spool 20. Plural projecting portions 21A are disposed at the ring 21 along the peripheral direction at a uniform interval. Moreover, a rotational angle sensor 110 that senses the rotational angle of the ring 21 is provided at a position near the ring 21. This rotational angle sensor 110 is electrically connected to a control device 100 that is described later. The rotational angle sensor 110 of the present embodiment is a magnetic sensor, and can detect the rotational angle by detecting changes in the magnetic flux by the magnetic sensor that is near to the projecting portions 21A of the ring 21. Because the ring 21 is connected to the spool 20 as described above, due to the angle of the ring 21 being detected, the control device 100 can acquire the rotational angle of the spool 20. Note that the rotational angle sensor 110 is not limited to a magnetic sensor, and may be an optical sensor.

An accommodating hole 24, whose spool 20 radial direction outer side is open, is formed in the one end 20A of the spool 20. A lock pawl 26, which is shaped as an elongated plate and serves as a restricting member and structures a locking mechanism 18, is movably accommodated in the accommodating hole 24. A lock tooth 26A is formed at one end of the lock pawl 26. An operation shaft 28 that is solid cylindrical is provided integrally with the lock pawl 26. The operation shaft 28 projects-out from the lock pawl 26 toward the rear side.

A rotation shaft 30 that is solid cylindrical is provided integrally with the axially central portion of the one end 20A of the spool 20. The rotation shaft 30 projects-out from the spool 20 toward the rear side and is disposed coaxially with the spool 20.

A sensor mechanism 32 that structures the locking mechanism 18 is provided at the rear side of the frame 12 (the rear side of the leg plate 12B).

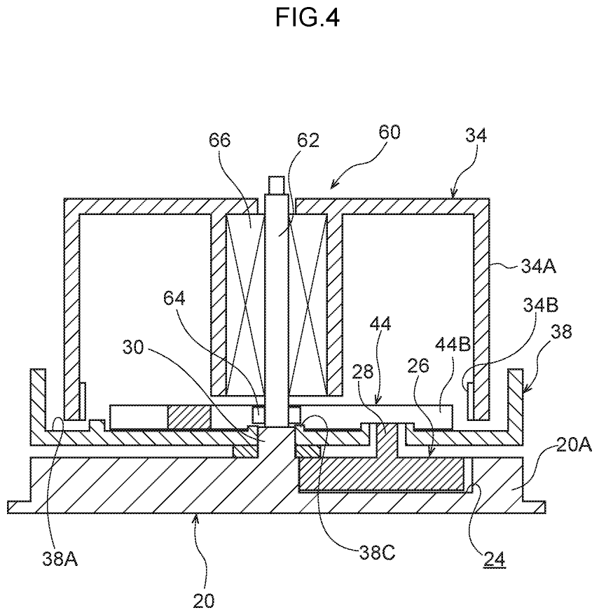

The sensor mechanism 32 has a sensor holder 34 that is substantially shaped as a cylindrical tube having a bottom, and that is formed by using a resin material, and whose front side (leg plate 12B side) is open. The sensor holder 34 is fixed to the leg plate 12B. An inner tube portion 34A (see FIG. 4) that is cylindrical tube shaped is formed at the inner side of the sensor holder 34, and the inner tube portion 34A is disposed coaxially with the spool 20.

A sensor cover 36, which is substantially shaped as a cylindrical tube having a bottom and is formed by using a resin material and whose front side is open, is provided at the rear side (the side opposite the leg plate 12B) of the sensor holder 34. The sensor cover 36 is fixed to the leg plate 12B in a state in which the sensor holder 34 is accommodated at the interior of the sensor cover 36.

A V gear 38 that serves as a rotating body is provided within the sensor holder 34. The V gear 38 is formed in the shape of a cylindrical tube having a bottom, and is formed by using a resin material, and the rear side thereof is open. A tubular portion 38C that is formed in the shape of a tube stands erect at the axially central portion of a bottom wall 38A of the V gear 38. Due to the rotating shaft 30 of the spool 20 being inserted in the tubular portion 38C, the V gear 38 can rotate with respect to the spool 20.

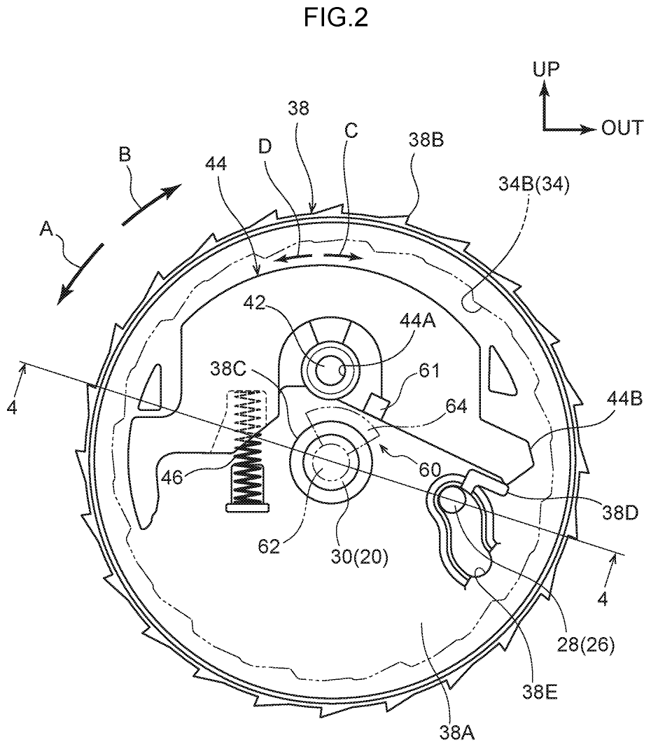

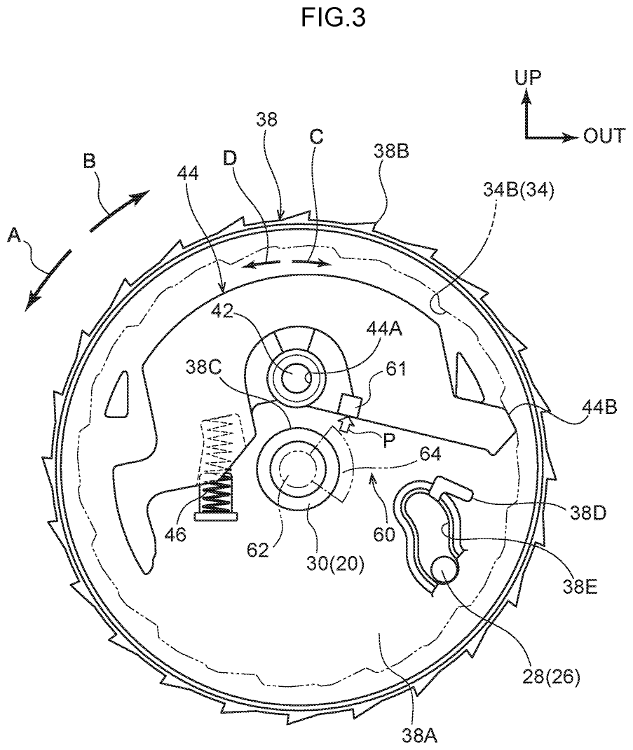

An operation groove 38E that is elongated is formed in the bottom wall 38A of the V gear 38 (see FIG. 2 and FIG. 3). The operation shaft 28 of the lock pawl 26 is inserted in the operation groove 38E. A compression coil spring 40 is interposed between the V gear 38 and the one end 20A of the spool 20. The compression coil spring 40 urges the V gear 38 in the pull-out direction with respect to the spool 20 (urges the spool 20 in the take-up direction with respect to the V gear 38), and makes the operation shaft 28 abut a length direction one end of the operation groove 38E. Due thereto, rotation of the V gear 38 in the pull-out direction with respect to the spool 20 due to the urging force of the compression coil spring 40 is stopped, and the V gear 38 can rotate around the rotating shaft 30 of the spool 20 accompanying the rotation of the spool 20. Ratchet teeth 38B (external teeth) are formed at the entire outer periphery of the V gear 38.

A swinging shaft 42 that is solid cylindrical stands erect at the bottom wall 38A of the V gear 38. The swinging shaft 42 is disposed at the radial direction outer side with respect to the central axis of the V gear 38. Further, the central axis of the swinging shaft 42 and the central axis of the V gear 38 are parallel.

As shown in FIG. 2, a W pawl 44, which serves as an operating member and a pawl body, is supported at the swinging shaft 42 so as to be able to swing (so as to be able to be displaced). In detail, as seen in a front view, the W pawl 44 is formed in a U-shape whose V gear 38 axially central portion side is open. A swinging shaft insertion hole 44A into which the swinging shaft 42 is inserted is formed at an intermediate portion in the peripheral direction of the W pawl 44 (the peripheral direction of the V gear 38). Further, a peripheral direction another side end portion of the W pawl 44 is an engaging portion 44B that engages with an engaged portion 34B that is at the distal end of the inner tube portion 34A of the sensor holder 34. Moreover, a permanent magnet 61 that is rectangular parallelepiped is fit-together with a portion which is at the peripheral direction another side of the W pawl 44 and is toward the swinging shaft insertion hole 44A. This permanent magnet 61 is disposed so as to face an excitation portion 64 that is described later.

A return spring 46 is interposed between the W pawl 44 and the V gear 38. The return spring 46 urges the W pawl 44 in a returning direction (the direction of arrow C). Moreover, swinging of the W pawl 44 in the returning direction by the urging force of the return spring 46 is stopped by a restricting projecting portion 38D that is provided at the V gear 38.

When the V gear 38 is rotated in the pull-out direction, inertial force in the take-up direction with respect to the V gear 38 is applied to the W pawl 44. Due thereto, the W pawl 44 starts to swing in an operating direction (the arrow D direction) with respect to the V gear 38. Moreover, at the time when the V gear 38 is rapidly rotated in the pull-out direction, the inertial force that is applied to the W pawl 44 exceeds the urging force of the return spring 46. Due thereto, the W pawl 44 is swung in the operating direction with respect to the V gear 38, and the engaging portion 44B of the W pawl 44 engages with the engaged portion 34B of the sensor holder 34. Namely, rotation of the V gear 38 in the pull-out direction is stopped due to the V gear 38 being anchored by the W pawl 44.

As shown in FIG. 1, an acceleration sensor 48 is provided at the lower end portion of the sensor holder 34. The acceleration sensor 48 has a housing 50 that is substantially U-shaped and whose upper side is open, as seen in a vehicle front view. A curved surface 50A that is concave is formed at the upper surface of the bottom wall of the housing 50. A ball 52 that is spherical and serves as an inertial mass body is placed on the curved surface 50A. A lever 54 that is substantially plate-shaped and serves as a lever body is placed on the upper side of the ball 52. At the proximal end thereof, the lever 54 is pivotably supported at a side wall of the housing 50. The V gear 38 is disposed at the upper side of the distal end of the lever 54. Due to the ball 52 rolling on the curved surface 50A of the housing 50 and being raised up, the lever 54 is pivoted toward the upper side. Due thereto, the distal end of the lever 54 meshes-together with (anchors on) the ratchet tooth 38B of the V gear 38, and rotation of the V gear 38 in the pull-out direction is stopped.

As shown in FIG. 4, an interlocking shaft 62 is disposed at the axially central portion of the inner tube portion 34A that is at the inner side of the sensor holder 34. This interlocking shaft 62 is disposed coaxially with the rotating shaft 30 of the spool 20, and is connected to the rotating shaft 30. Therefore, the interlocking shaft 62 rotates interlockingly with the spool 20. Further, as shown in FIG. 2, the excitation portion 64, which is fan-shaped as seen from the axial direction and projects-out from the interlocking shaft 62 toward the swinging shaft 42 (the W pawl 44) side, is provided in a vicinity of the front side (the rotating shaft 30 side) end portion of the interlocking shaft 62. The excitation portion 64 is an example of the projecting portion. The interlocking shaft 62 and the excitation portion 64 of the present embodiment are metal conductors made of iron or the like, and the interlocking shaft 62 and the excitation portion 64 are formed integrally. Moreover, a coil 66 is provided at the inner tube portion 34A so as to surround the periphery of the interlocking shaft 62. The coil 66 is electrically connected to the control device 100 that is described later. In the present embodiment, an electromagnetic actuator 60, which serves as the driving portion and operates by the magnetic force of an electromagnet, is structured by the permanent magnet 61 that is provided at the W pawl 44, and the interlocking shaft 62, the excitation portion 64 and the coil 66 that are provided at the inner tube portion 34A.

For example, in a case in which the excitation portion 64 side of the permanent magnet 61 is the N pole, due to the coil 66 being energized and the rotation shaft 30 side (i.e., the excitation portion 64) of the interlocking shaft 62 being excited so as to become the N pole, repulsion is generated between the permanent magnet 61 and the excitation portion 64 (refer to arrow P in FIG. 3). As described above, usually, the W pawl 44 is urged in the returning direction (the arrow C direction) by the return spring 46 (see FIG. 2). However, due to the permanent magnet 61 and the excitation portion 64 repelling one another, the W pawl 44 starts to swing in the operating direction (the arrow D direction) with respect to the V gear 38. When the repulsion that is applied to the permanent magnet 61 exceeds the urging force of the return spring 46, the W pawl 44 to which the permanent magnet 61 is fixed is swung in the operating direction with respect to the V gear 38, and the engaging portion 44B of the W pawl 44 engages with the engaged portion 34B of the sensor holder 34.

As described above, at the time when rotation of the V gear 38 in the pull-out direction is stopped, when the spool 20 is rotated in the pull-out direction with respect to the V gear 38 against the urging force of the compression coil spring 40, the operation shaft 28 of the lock pawl 26 is moved toward the length direction another end side of the operation groove 38E of the V gear 38, and the lock pawl 26 is moved toward the radial direction outer side of the spool 20 (the one end 20A). Due thereto, the lock tooth 26A of the lock pawl 26 meshes-together with the ratchet tooth 14A of the frame 12 (the leg plate 12B), and rotation of the spool 20 in the pull-out direction is locked (restricted). As a result, pulling-out of the webbing 22 from the spool 20 is locked (restricted). As described above, in the present embodiment, the operating mechanism that operates the lock pawl 26 is structured by the electromagnetic actuator 60, the W pawl 44 and the V gear 38.

Note that, as shown in FIG. 3, when the spool 20 is rotated in the pull-out direction with respect to the V gear 38, the interlocking shaft 62 also rotates interlockingly with the spool 20. In this case as well, the excitation portion 64 is disposed so as to face the permanent magnet 61 that is provided at the W pawl 44.

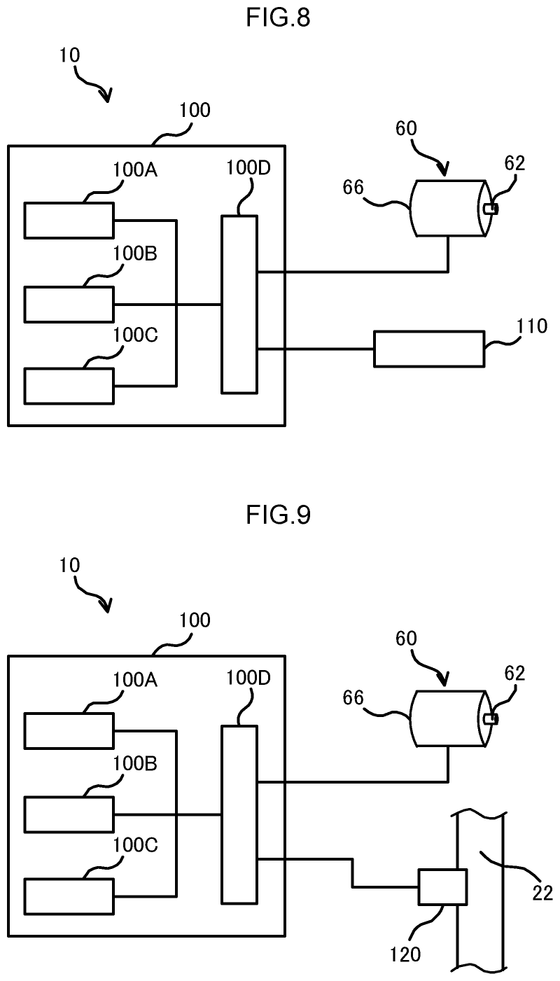

As shown in FIG. 1, the control device 100 that serves as a control section and controls the electromagnetic actuator 60 is provided at the webbing retractor 10 of the present embodiment. As shown in FIG. 8, the control device 100 has a CPU (Central Processing Unit) 100A, a ROM (Read Only Memory) 100B, a RAM (Random Access Memory) 100C, and an input/output interface (I/O) 100D. These respective sections are connected via a bus. In addition to the coil 66 of the electromagnetic actuator 60, at least the rotational angle sensor 110 is electrically connected to the I/O 100D of the control device 100. The rotational angle sensor 110 is always detecting the rotational angle of the spool 20.

The control device 100 of the present embodiment acquires the rotational angle of the spool 20 that is detected by the rotational angle sensor 110. The control device 100 computes the angular velocity from the amount of change, per unit time, in the acquired rotational angle, and computes and acquires the acceleration of the webbing 22 based on the angular velocity and a predetermined factor (the standard wound diameter of the webbing 22 at the spool 20). Further, the control device 100 differentiates the acquired acceleration of the webbing 22, and computes the jerk which is the derivative of the acceleration of the webbing 22. Based on the computed acceleration and jerk of the webbing 22, the control device 100 drives the electromagnetic actuator 60 that structures the operating mechanism.

Concretely, in the present embodiment, an acceleration threshold value that is a first threshold value is set for the acceleration, and a jerk threshold value that is a second threshold value is set for the jerk. The control device 100 energizes the coil 66 in a case in which both conditions, which are the acceleration exceeding the acceleration threshold value and the jerk exceeding the jerk threshold value, are established. Due thereto, the electromagnetic actuator 60 is driven, and the W pawl 44 engages with the V gear 38, and pulling-out of the webbing 22 from the spool 20 is thereby restricted. Note that the ratchet teeth 14A of the frame 12 (the leg plate 12B) permit rotation of the spool 20 in the take-up direction, and the engaged portion 34B of the sensor holder 34 permits rotation of the V gear 38 in the take-up direction.

Note that the present embodiment is structured such that the W pawl 44 operates by the electromagnetic actuator 60 earlier than the WSIR mechanism operates. Therefore, the acceleration threshold value of the webbing 22 is set to be a lower value than the acceleration of the webbing 22 in a case in which the W pawl 44 swings in the operating direction.

On the other hand, at the control device 100 of the present embodiment, in a case in which both the acceleration condition and the jerk condition are satisfied and the electromagnetic actuator 60 is being driven, if the acceleration falls below the acceleration threshold value, energizing of the coil 66 is stopped, and driving of the electromagnetic actuator 60 is stopped. Due thereto, the engagement of the W pawl 44 with the V gear 38 is released.

As described above, in the present embodiment, the WSIR mechanism, which is operated due to the rotational acceleration of the spool 20 in the pull-out direction exceeding a predetermined magnitude, is structured by the W pawl 44, the V gear 38 and the locking mechanism 18. Further, the VSIR mechanism, which is operated due to the acceleration of the vehicle exceeding a predetermined magnitude, is structured by the acceleration sensor 48 and the locking mechanism 18. On the other hand, in addition to the W pawl 44, the V gear 38 and the locking mechanism 18 that structure the WSIR mechanism, the locking mechanism 18 can be operated electrically by the electromagnetic actuator 60, the rotational angle sensor 110 and the control device 100.

### Operation and Effects of Present Embodiment

Operation and effects of the present embodiment are described next.

At the webbing retractor 10 of the above-described structure, due to the webbing 22 being pulled, and the spool 20 and the V gear 38 being rotated in the pull-out direction against the urging force of the spiral spring, the webbing 22 is pulled-out from the spool 20, and is set in in a latched state and applied to the passenger.

A case in which the VSIR mechanism operates is as follows. Namely, at the time when the vehicle rapidly decelerates, at the acceleration sensor 48, the ball 52 rolls on the curved surface 50A of the housing 50 and is raised up. Due thereto, the lever 54 is pivoted toward the upper side, and the distal end thereof is meshed-together with (anchored on) the ratchet tooth 38B of the V gear 38. Due thereto, rotation of the V gear 38 in the pull-out direction is stopped.

A case in which the WSIR mechanism operates is as follows. Namely, at the time when the vehicle rapidly decelerates, due to the passenger being moved by inertial force, the webbing 22 is pulled-out from the spool 20 by the passenger, and the spool 20 and the V gear 38 are rotated rapidly in the pull-out direction. At the time when the V gear 38 is rotated rapidly in the pull-out direction, the W pawl 44 is swung in the operating direction with respect to the V gear 38, and the engaging portion 44B of the W pawl 44 engages with the engaged portion 34B of the sensor holder 34, and rotation of the V gear 38 in the pull-out direction is stopped.

As described above, the present embodiment is structured such that, at the time when the passenger moves due to inertial force, the W pawl 44 is operated by the electromagnetic actuator 60 earlier than the WSIR mechanism operates. Namely, the WSIR mechanism is a failsafe mechanism for a case in which a problem arises with the operating mechanism that includes the electromagnetic actuator 60. The conditions for operation of the W pawl 44 by the electromagnetic actuator 60 are as follows.

In the same way as the WSIR mechanism, at the time when the vehicle rapidly decelerates, due to the passenger being moved by inertial force, the webbing 22 is pulled-out from the spool 20 by the passenger, and the spool 20 is rapidly rotated in the pull-out direction. Accompanying the rotation of the ring 21 that is connected to the spool 20, the rotational angle sensor 110 detects the rotational angle of the spool 20. As described above, the control device 100, which acquires the rotational angle of the spool 20 that has been detected by the rotational angle sensor 110, computes the acceleration and the jerk of the webbing 22. Here, the control device 100 carries out judgments as to whether the acceleration exceeds the acceleration threshold value, and whether the jerk exceeds the jerk threshold value, respectively.

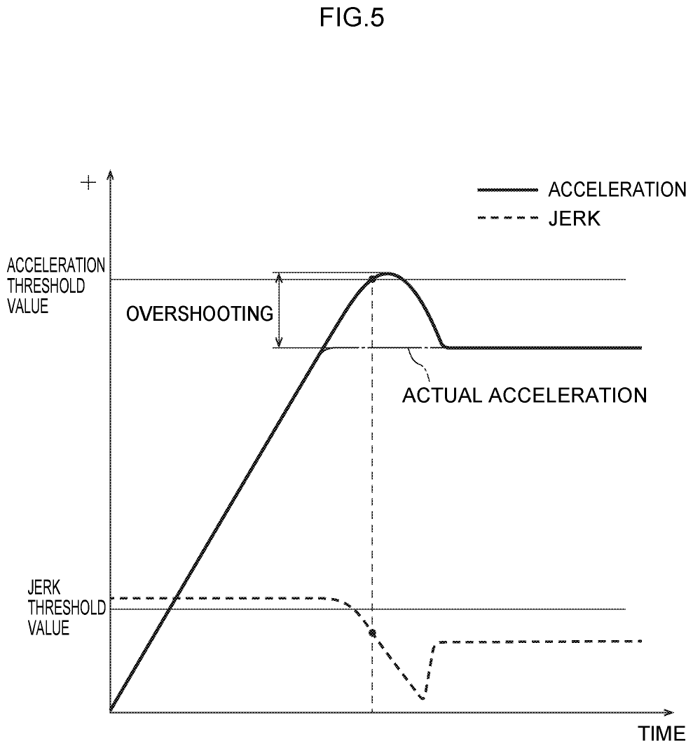

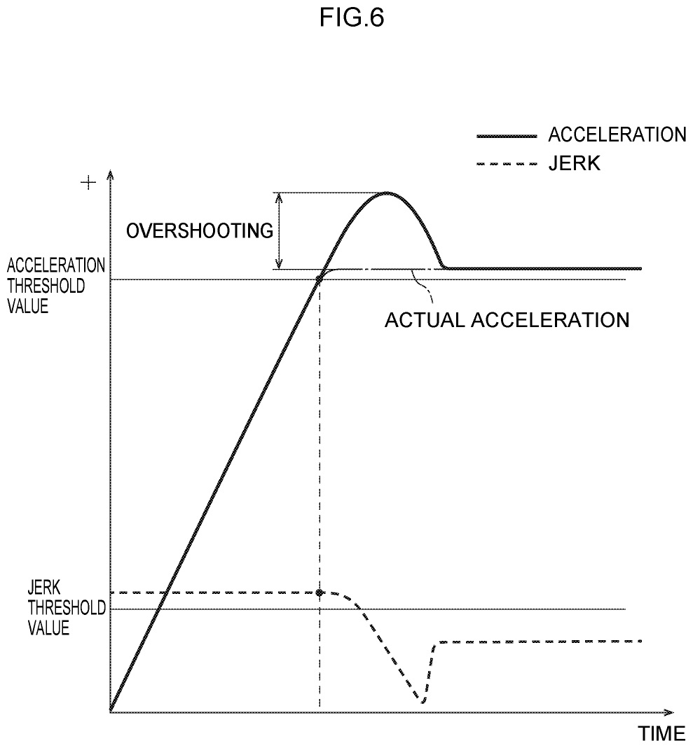

Graphs of the acceleration and the jerk of the webbing 22 are shown in FIG. 5 and FIG. 6. Note that, in FIG. 5 and FIG. 6, the horizontal axis of the graph is time, and the vertical axis is acceleration of the webbing 22 with the pull-out direction of the spool 20 being positive, and jerk with a case in which the acceleration increases being positive. For explanation, the acceleration and the jerk are shown on the same graph, but the scale values thereof are respectively different.

As shown in FIG. 5 and FIG. 6, it is assumed that overshooting is detected at the control device 100 at the time when the acceleration of the webbing 22 increases due to rapid deceleration of the vehicle. In the case of the example of FIG. 5, the control device 100 judges that the acceleration exceeds the acceleration threshold value. Here, in a case in which only acceleration is made to be the operating condition of the electromagnetic actuator 60, the electromagnetic actuator 60 is driven regardless of the fact that the actual acceleration does not exceed the acceleration threshold value. However, at the point in time that the acceleration reaches the acceleration threshold value, the control device 100 of the present embodiment judges that the jerk does not exceed the jerk threshold value. Accordingly, at the control device 100, because both the acceleration condition and threshold value condition are not established, the control device 100 does not drive the electromagnetic actuator 60.

On the other hand, in the case of the example of FIG. 6, at the control device 100, it is judged that the acceleration exceeds the acceleration threshold value. At the point in time when the acceleration reaches the acceleration threshold value, the control device 100 judges that the jerk exceeds the jerk threshold value. Accordingly, at the control device 100, because both the condition relating to the acceleration and the condition relating to the threshold value are established, the control device 100 drives the electromagnetic actuator 60. In this case, the electromagnetic actuator 60 is driven in a situation in which the actual acceleration exceeds the acceleration threshold value. Further, accompanying the driving of the electromagnetic actuator 60, the W pawl 44 is swung in the operating direction with respect to the V gear 38, and the engaging portion 44B of the W pawl 44 engages with the engaged portion 34B of the sensor holder 34, and rotation of the V gear 38 in the pull-out direction is stopped.

At the time when the rotation of the V gear 38 in the pull-out direction is stopped, due to the spool 20 being rotated in the pull-out direction with respect to the V gear 38 and against the urging force of the compression coil spring 40, the operation shaft 28 of the lock pawl 26 is moved to the length direction another end side of the operation groove 38E of the V gear 38, and the lock pawl 26 is moved toward the radial direction outer side of the spool 20. Due thereto, the lock tooth 26A of the lock pawl 26 meshes-together with the ratchet tooth 14A of the frame 12, and rotation of the spool 20 in the pull-out direction is locked. Due thereto, pulling-out of the webbing 22 from the spool 20 is locked, and the passenger is restrained by the webbing 22.

On the other hand, when application of the webbing 22 to the passenger is released, the spool 20 and the V gear 38 are rotated in the take-up direction by the urging force of the spiral spring, and the webbing 22 is taken-up onto the spool 20.

Note that in a case in which both the acceleration condition and the jerk condition are established and the electromagnetic actuator 60 is being driven, the control device 100 stops the driving of the electromagnetic actuator 60 in a case in which the acceleration falls below the acceleration threshold value. Due thereto, the engagement of the engaging portion 44B of the W pawl 44 with the engaged portion 34B of the V gear 38 is cancelled. Namely, the state in which pulling-out of the webbing 22 is locked can be released.

As described above, the webbing retractor 10 of the present embodiment is structured such that the locking mechanism 18 operates accompanying the driving of the electromagnetic actuator 60 that is driven electrically, and pulling-out of the webbing 22 is restricted due to the electromagnetic actuator 60 being driven electrically. Further, the control device 100 of the present embodiment is structured such that the locking mechanism 18 is operated in a case in which the acceleration of the webbing 22 exceeds the acceleration threshold value and the jerk exceeds the jerk threshold value.

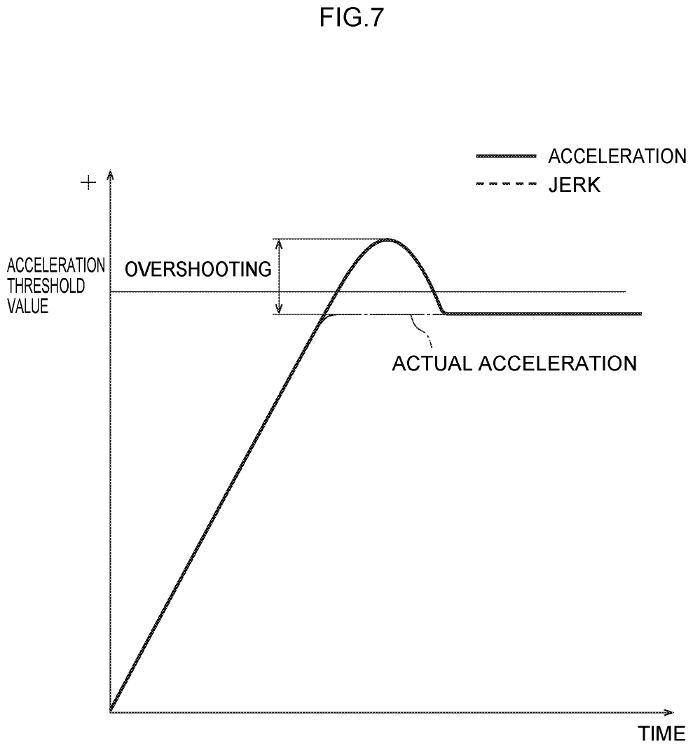

Here, a comparative example of a case in which only acceleration is made to be the operating condition of the electromagnetic actuator 60 is shown in FIG. 7. This drawing is a graph showing acceleration of the webbing 22. The horizontal axis is time, and the vertical axis is the acceleration of the webbing 22 with the pull-out direction of the spool 20 being positive.

As shown in FIG. 7, it is assumed that overshooting is detected at the control device 100 at the time when the acceleration of the webbing 22 increases due to sudden deceleration of the vehicle. In the case of the comparative example, the electromagnetic actuator 60 is driven even though the actual acceleration does not exceed the acceleration threshold value. Namely, the locking mechanism 18 operates at a lower acceleration than in actuality.

In contrast, in the present embodiment, even in a case in which the acquired acceleration overshoots and exceeds the acceleration threshold value due to the effects of noise or the like, the control device 100 does not operate the locking mechanism 18 unless the jerk exceeds the jerk threshold value (see FIG. 5). Therefore, the locking mechanism 18 operating regardless of the fact that the actual acceleration does not exceed the threshold value, as is the case in the comparative example, is suppressed. In accordance with the webbing retractor 10 of the present embodiment, the effects of noise can be suppressed at the locking mechanism 18 that uses acceleration in control and that is operated electrically.

Further, as shown in FIG. 5 and FIG. 6, the jerk decreases at the portion where there is overshooting. Therefore, by using both acceleration and jerk in controlling the operation of the locking mechanism 18 as in the present embodiment, switching between low acceleration and high acceleration can be carried out easily.

On the other hand, in the webbing retractor 10 of the present embodiment, stopping of operation of the locking mechanism 18 is carried out by control that uses only acceleration as a condition. In accordance with the present embodiment, by stopping operation of the locking mechanism 18 based on only the acceleration and regardless of the jerk, operation of the locking mechanism 18 can be stopped rapidly even in a case in which the acquired acceleration value is not stable, i.e., a case in which the jerk moves vertically.

Moreover, in the webbing retractor 10 of the present embodiment, the acceleration of the webbing 22 is acquired from the rotational angle of the spool 20. In accordance with the present embodiment, because the rotational angle sensor can be provided at any of the rotating bodies that rotate interlockingly with the spool 20, assembly into a device is easy, and compactness of the device can be devised.

### Second Embodiment

In the first embodiment, the acceleration of the webbing 22 is calculated based on the angular velocity, which is computed from the rotational angle, and a predetermined factor. Here, the predetermined factor is the standard wound diameter of the webbing 22 at the spool 20. However, the wound diameter of the webbing 22 increases as the amount of the webbing 22 that is wound on the spool 20 increases, and decreases as the amount of the webbing 22 that is wound on the spool 20 decreases. Thus, the second embodiment is structured such that the acceleration of the webbing 22 is corrected based on a rotational angle that is correlated with the wound amount of the webbing 22.

For example, the control device 100 can correct the acceleration of the webbing 22 based on a computational formula that adds the thickness of the webbing 22 to the total rotational angle of the spool 20. Further, for example, a correction table, in which correction values that correspond to total rotational angles of the spool 20 are stored, may be provided, and the control device 100 can correct the acceleration of the webbing 22 by applying the correction value that corresponds to the total rotational angle of the spool 20 that is detected by the rotational angle sensor 110. Note that the control device 100 may carry out correction after computing the wound amount of the webbing 22 at the spool 20 based on a rotational angle of the spool 20.

In a case in which effects of the wound diameter of the webbing 22 are not corrected, the more the webbing 22 is pulled-out, the smaller the acceleration of the webbing 22 is computed to be. In contrast, in accordance with the webbing retractor 10 of the present embodiment, by correcting the acceleration of the webbing 22 based on the rotational angle that is correlated with the wound amount of the webbing 22, the locking mechanism 18 can be operated based on more accurate acceleration and jerk.

### Modified Example of Second Embodiment

As a modified example of the present embodiment, at the control device 100, at least one of the acceleration threshold value and the jerk threshold value may be changed in a stepwise manner, instead of correcting the acceleration of the webbing 22 based on the rotational angle. In this case, the acceleration threshold value and the jerk threshold value can be changed in accordance with the rotational angle, by using a correction table such as that described above. In accordance with the webbing retractor 10 of the present embodiment, the locking mechanism 18 can be operated accurately by correcting the threshold value, which is the object of comparison with the acceleration, instead of correcting the acceleration.

Note that, in the modified example of the present embodiment, both the acceleration threshold value and the jerk threshold value may be corrected, or either of the acceleration threshold value and the jerk threshold value may be corrected. In a case in which fluctuations in the wound amount of the webbing 22 at the spool 20 are to be corrected, it suffices to correct only the acceleration threshold value. Further, in a case in which the degree of generation of noise varies in accordance with the wound amount of the webbing 22, the sensitivity at the time when the electromagnetic actuator 60 is driven can be adjusted by correcting the jerk threshold value.

### Third Embodiment

The webbing retractor 10 of the third embodiment uses a pulled-out amount sensor, which senses the pulled-out amount of the webbing 22, in controlling the locking mechanism 18. As shown in FIG. 9, in the present embodiment, a pulled-out amount sensor 120 is disposed on the path of the webbing 22, such as at the upper portion of the frame 12 or the like. A laser displacement gauge for example can be used as the pulled-out amount sensor 120. The pulled-out amount sensor 120 of the present embodiment is electrically connected to the control device 100. The control device 100 computes and acquires the acceleration of the webbing 22 from the pulled-out amount of the webbing 22 that is acquired by the pulled-out amount sensor 120. Note that, in the present embodiment, the sensor that provides input to the control device 100 is changed from the rotational angle sensor 110 of the first embodiment to the pulled-out amount sensor 120, but the other structures and the method of control by using the computed acceleration and jerk are the same as in the first embodiment.

In the webbing retractor 10 of the present embodiment, the pulled-out amount of the webbing 22 is used in acquiring the acceleration of the webbing 22. In accordance with the present embodiment, because control is not affected by the state of winding of the webbing 22 at the spool 20, the locking mechanism 18 can be operated accurately.

### Fourth Embodiment

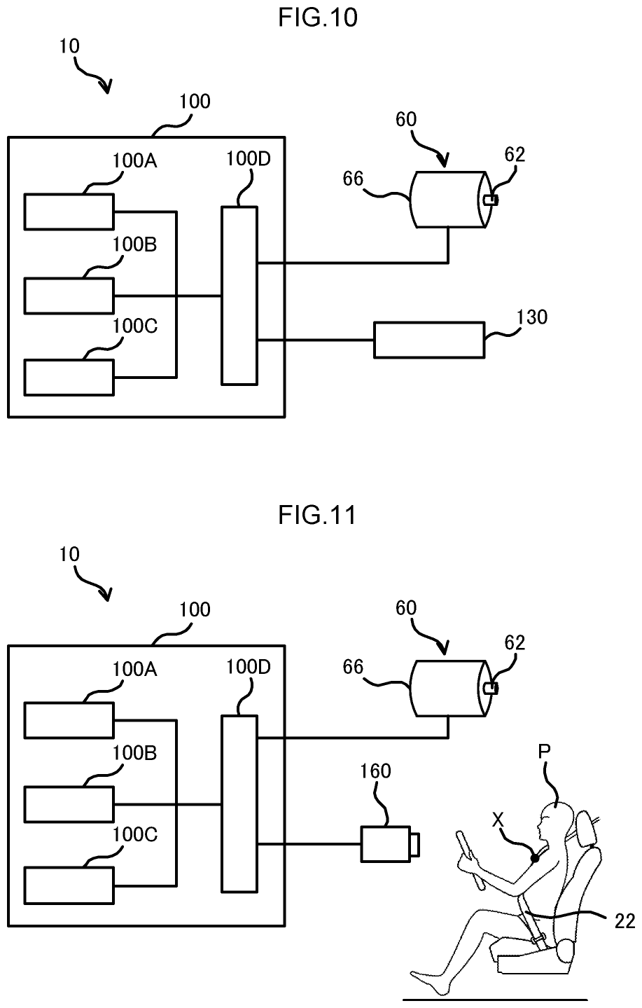

The webbing retractor 10 of the fourth embodiment uses an acceleration sensor, that detects the acceleration of the vehicle, in the controlling of the locking mechanism 18. As shown in FIG. 10, in the present embodiment, an acceleration sensor 130 is installed in the vehicle body. This acceleration sensor 130 is, for example, a sensor that structures a collision predicting device that predicts a collision of the vehicle. The acceleration sensor 130 of the present embodiment is electrically connected to the control device 100. At the control device 100, the acceleration of the vehicle that is acquired from the acceleration sensor 130 is used as is in the judgment with the acceleration threshold value. Note that, in the present embodiment, the sensor that provides input to the control device 100 is changed from the rotational angle sensor 110 of the first embodiment to the acceleration sensor 130, but the other structures and the method of control by using the computed acceleration and jerk are the same as in the first embodiment.

In the webbing retractor 10 of the present embodiment, the acceleration of the vehicle is made to be the operating condition of the locking mechanism 18. In accordance with the present embodiment, because the acceleration sensor 130 that is provided at the vehicle can be utilized, the cost of the device can be kept down.

### Fifth Embodiment

The sensor that the control device 100 uses in the control to operate the locking mechanism 18 is not limited to the above-described the rotational angle sensor 110, the pulled-out amount sensor 120 and the acceleration sensor 130. As shown in FIG. 11, in the webbing retractor 10 of the fifth embodiment, a camera 160 that captures images of a passenger P is provided within the vehicle cabin, and the control device 100 analyzes the images of the passenger P that are captured by the camera 160, and computes the acceleration of the passenger P. Concretely, the control device 100 tracks a fixed point X on the body of the passenger P that has been captured by the camera 160, and specifies the amount of movement of the passenger P per unit time, and computes the acceleration of the passenger P based on the specified amount of movement per unit time. Then, the control device 100 operates the locking mechanism 18 based on the acceleration of the passenger P and the computed jerk. Note that, in the present embodiment, the sensor that provides input to the control device 100 is changed from the rotational angle sensor 110 of the first embodiment to the camera 160, but the other structures and the method of control by using the computed acceleration and jerk are the same as in the first embodiment.

(Additional Points)

In the webbing retractor 10 of the above-described respective embodiments, the electromagnetic actuator 60 is provided as the driving portion that structures the operating mechanism. However, the present invention is not limited to this, and a motor may be provided as the driving portion, and the W pawl 44 may be operated by the motor.

Further, although the electromagnetic actuator 60 of the above-described respective embodiments directly operates the W pawl 44 by magnetic force of an electromagnet, the present invention is not limited to this, and the actuator may be a solenoid that operates the W pawl 44 by projecting-out a movable iron core (a plunger).

In the above-described respective embodiments, accompanying the driving of the electromagnetic actuator 60 that serves as the driving portion, usually, the locking mechanism 18 that is in a non-operating state is changed to the operating state. However, the present invention is not limited to this. For example, the locking mechanism 18 may be structured so as to be in a non-operating state while the electromagnetic actuator 60 is being driven, and the locking mechanism 18 may be changed to the operating state accompanying stoppage of driving of the electromagnetic actuator 60.

Although embodiments of the present disclosure have been described above, the present invention is not limited to the above, and can of course be implemented by being modified in various ways other than the above.

What is claimed is:

1. A webbing retractor comprising:
a take-up shaft that can take-up a webbing that is applied to a passenger, that takes-up the webbing by being rotated in a take-up direction, and that is rotated in a pull-out direction due to the webbing being pulled-out;
a restricting member that, by being operated, restricts rotation of the take-up shaft in the pull-out direction;
a driving portion that, by being electrically driven, changes an operating state of the restricting member; and
a control section that acquires an acceleration of any of the webbing, the passenger or a vehicle, that computes jerk related to the acceleration, and that controls the driving portion such that the restricting member operates in a case in which the acceleration exceeds a first threshold value and the jerk exceeds a second threshold value.

2. The webbing retractor of claim 1, further comprising a rotational angle sensor that detects a rotational angle of the take-up shaft,
wherein the control section acquires the acceleration of the webbing that is computed based on the rotational angle that is detected.

3. The webbing retractor of claim 2, wherein the control section corrects the acceleration of the webbing based on the rotational angle.

4. The webbing retractor of claim 2, wherein the control section changes at least one of the first threshold value or the second threshold value based on the rotational angle.

5. The webbing retractor of claim 1, further comprising a pulled-out amount sensor that detects a pulled-out amount of the webbing,
wherein the control section acquires the acceleration of the webbing that is computed based on the pulled-out amount that is detected.

6. The webbing retractor of claim 1, further comprising an acceleration sensor that detects the acceleration of the vehicle,
wherein the control section acquires the acceleration from the acceleration sensor.

7. The webbing retractor of claim 1, further comprising a camera that captures images of the passenger,
wherein the control section specifies an amount of movement per unit time of the passenger in the images captured by the camera, and
acquires the acceleration of the passenger, which is computed based on the amount of movement per unit time that is specified.

8. The webbing retractor of claim 1, wherein the control section drives the driving portion such that operation of the restricting member stops in a case in which the acceleration falls below the first threshold value.

9. The webbing retractor of claim 1, further comprising an operating mechanism that operates the restricting member by driving of the driving portion,
wherein the driving portion has:
an interlocking shaft that is disposed coaxially with the take-up shaft;
a coil that surrounds a periphery of the interlocking shaft and excites the interlocking shaft;
a projecting portion that is provided on the interlocking shaft so as to project-out, and that is excited together with the interlocking shaft; and
a magnet that is provided at the operating mechanism so as to face the projecting portion.
